(19) United States
(12) Patent Application Publication
(10) Pub. No.: US 2015/0200037 A1
(43) Pub. Date: Jul. 16, 2015

(54) Transparent Conductive Film, Dispersion Liquid, Information Input Device, and Electronic Equipment

(71) Applicant: Dexerials Corporation, Tokyo (JP)

(72) Inventor: Junichi INOUE, Tokyo (JP)

(73) Assignee: Dexerials Corporation, Tokyo (JP)

(21) Appl. No.: 14/597,604

(22) Filed: Jan. 15, 2015

(30) Foreign Application Priority Data
Jan. 16, 2014 (JP) 2014-006157

(51) Int. Cl. H01B 1/22; H01B 1/02

(52) U.S. Cl. CPC H01B 1/22; H01B 1/02

(57) ABSTRACT

Provided is a transparent conductive film that is capable of preventing the scattering of natural light and that has a low sheet resistance, a dispersion liquid with which the transparent conductive film is manufactured, an information input device that comprises the transparent conductive film, and an electronic equipment that comprises the transparent conductive film. The transparent conductive film comprises at least one metal nanowire. The at least one metal nanowire includes a metal nanowire body and a colored compound adsorbed to the metal nanowire body. The colored compound has a number average particle diameter in the range of 0.03 μm to 0.5 μm.

### CROSS-REFERENCE TO RELATED APPLICATION

This application claims priority to and the benefit of Japanese Patent Application No. 2014-006157 filed on Jan. 16, 2014, the entire contents of which are incorporated herein by reference.

### TECHNICAL FIELD

The present invention relates to a transparent conductive film, a dispersion liquid, an information input device, and an electronic equipment, and in particular to a transparent conductive film that includes at least one metal nanowire including a metal nanowire body and a colored compound adsorbed to the metal nanowire body, a dispersion liquid that contains the metal nanowire, an information input device that includes the transparent conductive film, and an electronic equipment that includes the transparent conductive film.

### BACKGROUND

Transparent conductive films, which are used for applications on display surfaces of display panels such as touch panels and in information input devices located on display surfaces of display panels, need to have a high light transmittance, and a metal oxide, such as Indium Tin Oxide (ITO), has been used as the material. However, the cost of such a transparent conductive film using the metal oxide is expensive due to the need for sputtering film deposition in a vacuum environment. Furthermore, the transparent conductive film using the metal oxide tends to crack or peel off especially when it is deformed due to, for example, bending and flexture.

In view of the above, as an alternative to the transparent conductive film using the metal oxide, being studied is a transparent conductive film using metal nanowires that may be formed by coating and printing and that is highly resistant to bending and flexture. The transparent conductive film using the metal nanowires is also attracting attention as a next-generation transparent conductive film that eliminates the use of indium, that is, a rare metal. (Refer to Japanese Patent Application Publication Nos. 2010-507199 and 2010-525526, for example.)

However, the transparent conductive film described in Japanese Patent Application Publication No. 2010-507199 might show redness and less transparency.

Furthermore, when the transparent conductive film using the metal nanowires is used in the application on the display surface of a display panel, surfaces of the metal nanowires reflect natural light diffusedly. This causes a “black float phenomenon” where the “black” level is slightly brighter. The black float phenomenon lowers the contrast of images, thereby deteriorating display characteristics.

As one approach to prevent the occurrence of the black float phenomenon, gold nanotubes using Gold (Au), which does not tend to cause the diffused reflection of light, have been proposed. Formation of the gold nanotubes first starts with application of a gold plating to a template of silver nanowires, which tend to cause the diffused reflection of light. Subsequently, the silver nanowire portions used as the template are etched or oxidized and converted into the gold nanotubes. (Refer to Japanese Patent Application Publication No. 2010-525527, for example.)

As another approach for preventing the diffused reflection of light, the one using a combination of metal nanowires and secondary conductive media (such as Carbon Nanotubes (CNTs), conductive polymers, and ITO) has been proposed. (Refer to Japanese Patent Application Publication No. 2010-525526.)

However, the gold nanotubes formed by the former approach inevitably waste the silver nanowires after the silver nanowires are used as the material of the template and also require gold as the material of the gold plating. This increases the cost of the materials and complicates the processes, resulting in the problem of high manufacturing cost.

The latter approach also faces the problem of loss of transparency because the secondary conductive media (coloring materials) such as the CNTs, the conductive polymers, and ITO are located in gaps in a network of the metal nanowires.

To solve the above problems, a transparent conductive film including metal nanowire bodies and colored compounds (dyes) adsorbed to the metal nanowire bodies has been proposed. (Refer to Japanese Patent Application Publication Nos. 2012-190777 and 2012-190780, for example.) In the proposed transparent conductive film including the metal nanowire bodies and the colored compounds (the dyes) adsorbed to the metal nanowire bodies, the colored compounds adsorbed to the metal nanowire bodies absorb visible light and prevent the diffused reflection of light on the surfaces of the metal nanowire bodies. The colored compounds (the dyes) adsorbed to the metal nanowire bodies included in the transparent conductive film are represented by, for example, the formula R-X, where R is a chromophoric group and X is an adsorptive functional group. Accordingly, the loss of transparency due to the addition of the colored compounds (the dyes) is prevented.

In the transparent conductive film including the metal nanowire bodies and the colored compounds, the colored compounds preferably coat the metal nanowire bodies at a single molecular level. Accordingly, such a transparent conductive film is typically formed by blending the colored compounds, the metal nanowire bodies, and a solvent, and applying a liquid of the colored compounds dissolved in the solvent onto a substrate. The solvent may be pure water, ethanol, n-propanol, i-propanol, or the like. The dispersibility, however, of metal nanowire bodies of thus formed transparent conductive film is not enough, and this might increase the sheet resistance of the film.

### SUMMARY

One or more embodiments of the present invention aims to solve the aforementioned problems in prior art and achieve the following objective. The objective of one or more embodiments of the present invention is to provide a transparent conductive film that is capable of preventing the scattering of natural light and that has a low sheet resistance, a dispersion liquid with which the transparent conductive film is manufactured, an information input device that includes the transparent conductive film, and an electronic equipment that includes the transparent conductive film.

The present inventors have conducted earnest studies to achieve the above objective and found the possibility of the transparent conductive film that is capable of preventing the scattering of natural light and that has a low sheet resistance, by optimizing the number average particle diameter of the colored compounds and by adsorbing the colored compounds to the metal nanowire bodies, while eliminating the need for coating the metal nanowire bodies with the colored compounds at the single molecular level. Thus, the present inventors have made the present invention.

The present invention is based on the findings of the present inventors, and aspects of the present invention for solving the aforementioned problems reside in the following.

<1> A transparent conductive film including at least one metal nanowire, wherein the at least one metal nanowire includes a metal nanowire body and a colored compound adsorbed to the metal nanowire body, and the colored compound has a number average particle diameter in the range of 0.03 μm to 0.5 μm.

In the transparent conductive film according to the aspect <1>, the number average particle diameter of the colored compound in the range of 0.03 μm to 0.5 μm effectively allows both the prevention of the scattering of natural light and the reduction in the sheet resistance of the transparent conductive film.

<2> The transparent conductive film of the aspect <1>, wherein the colored compound includes a chromophoric group having absorption in a visible light region and a group bonded to a metal constituting the metal nanowire body.

<3> The transparent conductive film of the aspect <1> or <2>, wherein the colored compound absorbs light in the visible light region.

<4> The transparent conductive film of any one of the aspects <1>-<3>, wherein the metal nanowire body has an average minor axis diameter of in the range of 1 nm to 500 nm and an average major axis length in the range of 5 μm to 50 μm.

<5> The transparent conductive film of any one of the aspects <1>-<4>, further including a binder, wherein the at least one metal nanowire is dispersed in the binder.

<6> The transparent conductive film of the aspect <2>, wherein the colored compound is represented by the formula R-X, where R is the chromophoric group having absorption in the visible light region, and X is the group bonded to the metal constituting the metal nanowire body.

<7> The transparent conductive film of the aspect <2>, wherein the chromophoric group includes at least one selected from the group consisting of an unsaturated alkyl group, an aromatic group, a heterocyclic ring, and a metal ion.

<8> The transparent conductive film of the aspect <2>, wherein the chromophoric group includes at least one selected from the group consisting of a nitroso group, a nitro group, an azo group, a methine group, an amino group, a ketone group, a thiazolyl group, a naphthoquinone group, an indoline group, a stilbene derivative, an indophenol derivative, a diphenylmethane derivative, an anthraquinone derivative, a triarylmethane derivative, a diazine derivative, an indigoid derivative, a xanthene derivative, an oxazine derivative, a phthalocyanine derivative, an acridine derivative, a thiazine derivate, a sulfur atom-containing compound, and a metal ion-containing compound.

<9> The transparent conductive film of the aspect <8>, wherein the chromophoric group includes at least one selected from the group consisting of a Cr complex, a Cu complex, a Co complex, a Ni complex, a Fe complex, an azo group, and an indoline group.

<10> The transparent conductive film of the aspect <2>, wherein the group bonded to the metal includes any one of a thiol group, a carboxylic acid group, and a phosphate group.

<11> The transparent conductive film of any one of the aspects <1>-<10>, wherein the metal nanowire body includes at least one element selected from the group consisting of Ag, Au, Ni, Cu, Pd, Pt, Rh, Ir, Ru, Os, Fe, Co, Sn, Al, Tl, Zn, Nb, Ti, In, W, Mo, Cr, V, and Ta.

<12> The transparent conductive film of any one of the aspects <1>-<11>, wherein a reflection L* value of the transparent conductive film is 9.5 or less.

<13> The transparent conductive film of any one of the aspects <1>-<12>, wherein the at least one metal nanowire is accumulated on a top of a substrate.

<14> The transparent conductive film of any one of the aspects <1>-<13>, wherein the colored compound has been processed according to a water flow dispersion method.

<15> The transparent conductive film of the aspect <14>, wherein the water flow dispersion method includes the step of flowing a solid-liquid mixture including the colored compound through a nozzle having a diameter of 1 mm or less and a length of 0.1 mm or more under a pressure of 50 MPa or more in an inlet of the nozzle.

<16> The transparent conductive film of the aspect <15>, wherein the step of flowing the solid-liquid mixture is repeated at least 3 times.

<17> The transparent conductive film of the aspect <15> or <16>, wherein the pressure is 100 MPa or more.

<18> A dispersion liquid including at least one metal nanowire, wherein the at least one metal nanowire includes a metal nanowire body and a colored compound adsorbed to the metal nanowire body, and the colored compound has a number average particle diameter in the range of 0.03 μm to 0.5 μm.

<19> The dispersion liquid of the aspect <18>, wherein the colored compound includes a chromophoric group having absorption in a visible light region and a group bonded to a metal constituting the metal nanowire body.

<20> The dispersion liquid of the aspect <18> or <19>, wherein the metal nanowire body has an average minor axis diameter in the range of 1 nm to 500 nm and an average major axis length in the range of 5 μm to 50 μm.

<21> The dispersion liquid of any one of the aspects <18>-<20>, further including an aqueous solvent.

<22> An information input device, including: a transparent substrate; and the transparent conductive film of any one of the aspects <1>-<17> that is disposed on the transparent substrate.

<23> An electronic equipment, including: a display panel; and the transparent conductive film of any one of the aspects <1>-<17> that is disposed on the display panel.

The present invention solves the aforementioned problems in prior art and achieves the aforementioned objective to provide the transparent conductive film that is capable of preventing the scattering of natural light and that has a low sheet resistance, the dispersion liquid with which the transparent conductive film is manufactured, the information input device that includes the transparent conductive film, and the electronic equipment that includes the transparent conductive film.

### BRIEF DESCRIPTION OF THE DRAWINGS

The present invention will be further described below with reference to the accompanying drawings, wherein:

FIG. 1 illustrates one example of a unit for processing according to a water flow dispersion method;

FIG. 2 is a schematic view illustrating a transparent electrode including a transparent conductive film according to a first embodiment of the present invention;

FIG. 3 is a schematic view illustrating a transparent electrode including a transparent conductive film according to a second embodiment of the present invention;

FIG. 4 is a schematic view illustrating a transparent electrode including a transparent conductive film according to a third embodiment of the present invention;

FIG. 5 is a schematic view illustrating a transparent electrode including a transparent conductive film according to a fourth embodiment of the present invention;

FIG. 6 is a schematic view illustrating a transparent electrode including a transparent conductive film according to a fifth embodiment of the present invention; and

FIG. 7 is a schematic view illustrating a transparent electrode including a transparent conductive film according to a sixth embodiment of the present invention.

### DETAILED DESCRIPTION

### (Transparent Conductive Film)

A transparent conductive film according to the present invention includes at least one metal nanowire and optionally includes other ingredients such as a binder.

### <Metal Nanowire>

The metal nanowire includes a metal nanowire body and a colored compound adsorbed to the metal nanowire body. (As used herein below, the term “a”, “an”, and “the” and similar referents are to be construed to cover both the singular and the plural, unless otherwise indicated herein or clearly contradicted by context.)

The colored compound, which is adsorbed to the metal nanowire body included in the metal nanowire, absorbs visible light or the like, thereby preventing the diffused reflection of light on a surface of the metal nanowire body.

The metal nanowire includes the one in which the colored compound is adsorbed to the entire metal nanowire body and the one in which the colored compound is adsorbed to at least a part of the metal nanowire body.

### <<Colored Compound>>

The colored compound may have any number average particle diameter in the range of 0.03 μm to 0.5 μm selected appropriately in accordance with the purpose without any limitation, and the colored compound preferably has a number average particle diameter in the range of 0.03 μm to 0.1 μm.

The number average molecular weight of less than 0.03 μm will result in an undue sheet resistance, and the number average molecular weight of more than 0.5 μm will result in failure to prevent the scattering of natural light satisfactorily. On the other hand, the number average particle diameter of the colored compound within the aforementioned preferable range is advantageous from the viewpoint of effectively achieving both the prevention of the scattering of natural light and the reduction in the sheet resistance.

The number average molecular weight of the colored compound may be measured by, for example, Laser Zeta Potential Meter “ELS-8000” manufactured by Otsuka Electronics Co., Ltd.

The colored compound preferably absorbs light in a visible light region. The “visible light region” herein refers to a wavelength band between 360 nm and 830 nm. Furthermore, the colored compound preferably includes a chromophoric group having absorption in the visible light region and a group bonded to a metal constituting the metal nanowire body. In particular, the colored compound is preferably represented by the formula R-X, where R is the chromophoric group having absorption in the visible light region, and X is the group (a portion) bonded to the metal constituting the metal nanowire body.

### —Chromophoric Group R—

The chromophoric group R may be any one having absorption in the visible light region selected appropriately in accordance with the purpose without any limitation. Examples of the chromophoric group R include an unsaturated alkyl group, an aromatic group, a heterocyclic ring, and a metal ion. These examples may be used alone or in a combination of two or more.

Among these examples, the aromatic group and the heterocyclic ring, in particular, cyanine, quinone, ferrocene, triphenylmethane, and quinoline are preferably used due to their capability of imparting improved transparency to the manufactured transparent conductive film.

Examples of the chromophoric group R include a nitroso group, a nitro group, an azo group, a methine group, an amino group, a ketone group, a thiazolyl group, a naphthoquinone group, an indoline group, a stilbene derivative, an indophenol derivative, a diphenylmethane derivative, an anthraquinone derivative, a triarylmethane derivative, a diazine derivative, an indigoid derivative, a xanthene derivative, an oxazine derivative, a phthalocyanine derivative, an acridine derivative, a thiazine derivate, a sulfur atom-containing compound, and a metal ion-containing compound. These examples may be used alone or in a combination of two or more.

Among these examples, a Cr complex, a Cu complex, a Co complex, a Ni complex, a Fe complex, an azo group, and an indoline group are preferably used due to their capability of imparting improved transparency to the manufactured transparent conductive film.

### —Portion X—

The portion X is the group bonded to the metal constituting the metal nanowire body that is later described.

The portion X may be selected appropriately in accordance with the purpose without any limitation, and examples of the portion X include a sulfo group (including a sulfonate salt), a sulfonyl group, a sulfonamide group, a carboxylic acid group (including a carboxylate salt), an amino group, an amide group, a phosphate group (including a phosphate and a phosphate ester), a phosphino group, a silanol group, an epoxy group, an isocyanate group, a cyano group, a vinyl group, a thiol group, a carbinol group, a hydroxyl group, and an atom that may coordinate to the metal constituting the metal nanowire (such as nitrogen (N), sulfur (S), and oxygen (O)). These examples may be used alone or in a combination of two or more.

Among these examples, the thiol group, the carboxylic acid group, and the phosphate group are preferably used due to their capability of preventing a decrease in conductivity caused by the adsorption of the colored compound.

### —Method of Manufacturing Colored Compound—

A method of manufacturing the colored compound may be determined appropriately in accordance with the purpose without any limitation. For example, the method of manufacturing the color compound may include the steps of (I) reacting a predetermined dye with a predetermined molecule to generate the colored compound and (II) subjecting the generated colored compound to processing according to a water flow dispersion method in order to optimize the particle diameter of the colored compound.

### --Step (I)--

The Step (I) is reacting the predetermined dye with the predetermined molecule to generate the colored compound.

The Step (I) may be determined appropriately in accordance with the purpose without any limitation. For example, the Step (I) may be any of the steps of (i) reacting a dye containing an acid group with a molecule containing a basic group, (ii) reacting a dye containing a basic group with a molecule containing an acid group, and (iii) reacting a dye containing a reactive group with a molecule containing a hydroxyl group.

---(i) Reaction of Dye Containing Acid Group with Molecule Containing Basic Group---

This reaction occurs between the acid group contained in the dye and the basic group contained in the molecule.

The dye containing the acid group may be selected appropriately in accordance with the purpose without any limitation. Examples of the dye containing the acid group include a commercially available acid dye, a metal complex salt acid dye, and a direct dye. These examples may be used alone or in a combination of two or more.

The molecule containing the basic group may be selected appropriately in accordance with the purpose without any limitation. Examples of the molecule containing the basic group include 2-aminoethanethiol, 2-aminoethanethiol hydrochloride, 2-dimethylaminoethanethiol hydrochloride, 2-(dimethylamino)ethanethiol hydrochloride, 2-diisopropylamino ethanethiol hydrochloride, 4-pyridine ethanethiol hydrochloride, 6-amino-1-hexanethiol hydrochloride, 8-amino-1-octanethiol hydrochloride, 11-amino-1-undecanethiol hydrochloride, 16-amino-1-hexadecanethiol hydrochloride, amino-EG6-undecanethiol hydrochloride, and amino-EG6-hexadecanethiol hydrochloride. These examples may be used alone or in a combination of two or more.

---(ii) Reaction of Dye Containing Basic Group with Molecule Containing Acid Group---

This reaction occurs between the basic group contained in the dye and the acid group contained in the molecule.

The dye containing the basic group may be selected appropriately in accordance with the purpose without any limitation. Examples of the dye containing the basic group include a commercially available cationic dye. These examples may be used alone or in a combination of two or more.

The molecule containing the acid group may be selected appropriately in accordance with the purpose without any limitation. Examples of the molecule containing the acid group include sodium 2-mercaptoethanesulfonate, sodium 3-mercapto-1-propanesulfonate, sodium 2,3-dimercaptopropane sulfonate, 4-[(5-mercapto-1,3,4-thiadiazol-2-yl)thio]-1-butanesulfonic acid sodium salt, sodium mercaptoacetate, sodium 2-(5-mercapto-1H-tetrazol-1-yl)acetate, 5-carboxy-1-pentanethiol, 7-carboxy-1-heptanethiol, 10-carboxy-1-decanethiol, 15-carboxy-1-pentadecanethiol, carboxy-EG6-undecanethiol, and carboxy-EG6-hexadecanethiol. These examples may be used alone or in a combination of two or more.

---(iii) Reaction of Dye Containing Reactive Group with Molecule Containing Hydroxyl Group---

This reaction occurs between the reactive group contained in the dye and the hydroxyl group contained in the molecule. Examples of the reactive group contained in the dye include a sulfateethylsulfonyl group, a vinylsulfonyl group, a monochloro-triazynyl group, a monofluoro-triazynyl group, a monopyridinio-triazinyl group, a dichloro-triazinyl group, a difluoromonochloropyrimidinyl group, and a trichloro-pyrimidinyl group.

The dye containing the reactive group may be selected appropriately in accordance with the purpose without any limitation. Examples of the dye containing the reactive group include a commercially available reactive dye. These examples may be used alone or in a combination of two or more.

The molecule containing the hydroxyl group may be selected appropriately in accordance with the purpose without any limitation. Examples of the molecule containing the hydroxyl group include 2-mercaptoethanol, 3-mercapto-1-propanol, 1-mercapto-2-propanol, 4-mercapto-1-butanol, 6-mercapto-1-hexanol, 3-mercapto-1-hexanol, 8-mercapto-1-octanol, 9-mercapto-1-nonanol, 11-mercapto-1-undecanol, and 1-thioglycerol. These examples may be used alone or in a combination of two or more.

### --Step (II)--

The Step (II) is subjecting the colored compound generated in the Step (I) to the processing according to the water flow dispersion method in order to optimize the particle diameter of the colored compound.

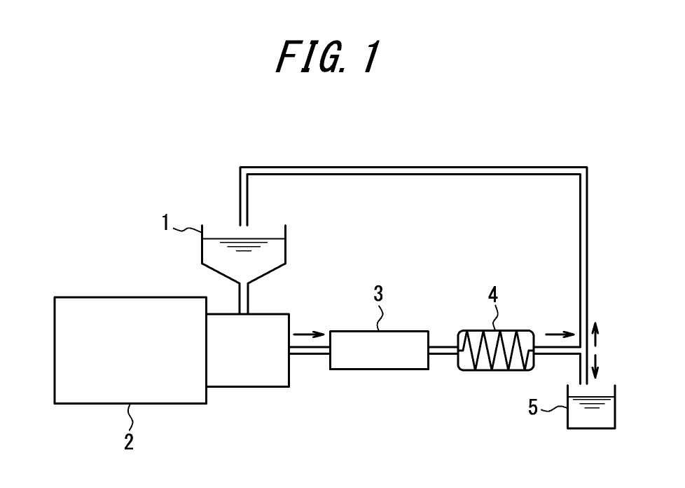

The “water flow dispersion method” herein refers to a method of mixing the colored compound with either one of an aqueous dispersion medium or a poor solvent and applying a shear force to the resulting solid-liquid mixture to crush (atomize) the agglomerated colored compound. The shear force may be applied to the solid-liquid mixture by any method selected appropriately in accordance with the purpose without any limitation. Examples of the method of applying the shear force include the one using a unit illustrated in FIG. 1. The following describes the unit illustrated in FIG. 1.

In the unit illustrated in FIG. 1, the solid-liquid mixture, which includes the colored compound and either one of the aqueous dispersion medium or the poor solvent, is charged into a feed container 1. Then, the solid-liquid mixture is flown through a nozzle 3 under a predetermined pressure applied by a pump 2 such as a plunger pump. The amount and rate of the flow of the solid-liquid mixture in the nozzle 3 are determined by three factors, namely, a pressure in the inlet of the nozzle 3, the diameter of the nozzle 3, and the length of the nozzle 3. The amount and rate of the flow of the solid-liquid mixture in turn determines the shear force. The shear force generated in the nozzle 3 is generally divided into two types, i.e., the shear force induced by a shear wave (a transverse wave) near the inlet of the nozzle and the shear force induced by a shear wave (a transverse wave) near the outlet of the nozzle. These types of shear force atomize the colored compound. The magnitude of the shear force to be applied to the colored compound may be regulated by appropriately controlling the aforementioned three factors. Subsequently, the solid-liquid mixture including the atomized colored compound is discharged from the nozzle 3, passes through an optionally provided heat exchanger 4. After passing through the heat exchanger 4, the solid-liquid mixture is either stored in a receiving container 5 or returned to the feed container 1 to be atomized in the nozzle 3 again. Additionally, between the “shear wave (a transverse wave) near the inlet of the nozzle” and the “shear wave (a transverse wave) near the outlet of the nozzle”, a “shock wave (a longitudinal wave) near the middle of the nozzle” may also be present.

Such a unit for the processing according to the water flow dispersion method may be made with a combination of industrially available devices and tools. In particular, as a device corresponding to the combination of the pump 2 and the nozzle 3, for example, “BERYU MINI” manufactured by Beryu Co., Ltd. may be used.

The feed container 1, the heat exchanger 4, and the receiving container 5 may be selected appropriately in accordance with the purpose without any limitation.

Meanwhile, although the solid-liquid mixture may be prepared before being charged into the feed container 1 as described above, it is also possible to prepare the solid-liquid mixture by charging the colored compound and either one of the dispersion or the poor solvent into the feed container 1 separately, and by mixing them in the container 1 with use of a mixer or the like.

The dispersion medium refers to an aqueous medium that does not dissolve the colored compound at all. The poor solvent refers to an aqueous medium that rarely dissolves the colored compound (e.g., with the proportion of the colored compound/the solvent at a temperature of 20° C. being 10 g/100 g or less).

The aqueous dispersion medium or the poor solvent for the colored compound manufactured through the reaction of the dye containing the acid group with the molecule containing the basic group may be, for example, water, ethanol, and i-propanol. The aqueous dispersion medium or the poor solvent for the colored compound manufactured through the reaction of the dye containing the basic group with the molecule containing the acid group may be, for example, water, ethanol, and i-propanol. The aqueous dispersion medium or the poor solvent for the colored compound manufactured through the reaction of the dye containing the reactive group with the molecule containing the hydroxyl group may be, for example, water, ethanol, and i-propanol. These examples may be used alone or in a combination of two or more.

Among these examples, water and ethanol are preferable from the viewpoint of dispersibility.

The solid-liquid mass ratio (solid/liquid) of the solid-liquid mixture may be selected appropriately in accordance with the purpose without any limitation and is preferably less than 10.0, more preferably less than 5.0, and most preferably less than 1.0.

The solid-liquid mass ratio (solid/liquid) of greater than 10.0 might cause clogging of the solid-liquid mixture in the nozzle. On the other hand, the solid-liquid mass ratio of the solid-liquid mixture within the aforementioned more preferable or most preferable range are advantageous from the viewpoints of effective application of the shear force and the prevention of the clogging of the solid-liquid mixture in the nozzle.

The diameter of the nozzle 3 illustrated in FIG. 1 may be selected appropriately in accordance with the purpose without any limitation and is preferably 1 mm or less, more preferably 500 μm or less, and most preferably 300 μm or less.

The diameter of the nozzle of greater than 1 mm might result in failure to apply a sufficient shear force to the colored compound, and therefore, failure to atomize the colored compound sufficiently. On the other hand, the diameter of the nozzle within the aforementioned more preferable or most preferable range is advantageous from the viewpoint of effectively increasing the pressure in the inlet of the nozzle.

The lower limit of the diameter of the nozzle may be determined appropriately in accordance with the purpose without any limitation and is preferably 30 μm or more from the viewpoint of the prevention of the clogging of the colored compound.

The length of the nozzle 3 illustrated in FIG. 1 may be selected appropriately in accordance with the purpose without any limitation and is preferably 10 mm or less, more preferably 5 mm or less, and most preferably 1 mm or less.

The length of the nozzle of greater than 10 mm will increase pressure loss due to pipe friction of the nozzle, generating the need for unduly increasing the pressure of the pump. On the other hand, the length of the nozzle within the aforementioned more preferable or most preferable range is advantageous from the viewpoint of creating a favorable pressure gradient between the inlet and the outlet of the nozzle and effectively applying the shear force.

The lower limit of the length of the nozzle may be determined appropriately in accordance with the purpose without any limitation and is preferably 0.01 mm or more from the viewpoint of sufficient generation of the shear wave in the nozzle.

The pressure in the inlet of the nozzle 3 illustrated in FIG. 1 may be selected appropriately in accordance with the purpose without any limitation and is preferably 50 MPa or more, more preferably 100 MPa or more, and most preferably 150 MPa or more.

The pressure in the inlet of the nozzle of less than 50 MPa may not produce a pressure gradient sufficient for the effective application of the shear force, and such a pressure might also lead to the clogging of the solid-liquid mixture in the nozzle. On the other hand, the pressure in the inlet of the nozzle within the aforementioned more preferable or most preferable range is advantageous from the viewpoints of the prevention of the clogging of the colored compound in the nozzle and the effective application of the shear force.

The upper limit of the pressure in the inlet of the nozzle may be determined appropriately in accordance with the purpose without any limitation and is preferably 200 MPa or less from the viewpoint of securing compatibility of the pump used.

The number of repetitions of the process of flowing the solid-liquid mixture containing the colored compound through the nozzle 3 in the water flow dispersion method illustrated in FIG. 1 may be appropriately selected in accordance with the purpose without any limitation and is preferably at least 3 times, more preferably at least 5 times, and most preferably at least 10 times.

The number of repetitions of 2 times or less might result in failure to sufficiently optimize the particle diameter of the colored compound. On the other hand, the number of repetitions within the aforementioned more preferable or most preferable range is advantageous from the viewpoint of the sufficient optimization of the particle diameter of the colored compound.

### <<Metal Nanowire Body>>

The metal nanowire body is constituted by using a metal and is a fine wire having a diameter of the order of nm.

The constituent element of the metal nanowire body may be any metallic element selected appropriately in accordance with the purpose without any limitation. Examples of the constituent element include Ag, Au, Ni, Cu, Pd, Pt, Rh, Ir, Ru, Os, Fe, Co, Sn, Al, Tl, Zn, Nb, Ti, In, W, Mo, Cr, V, and Ta. These examples may be used alone or in a combination of two or more.

Among these examples, Ag and Cu are preferable due to their high conductivity.

The average minor axis diameter of the metal nanowire body may be selected appropriately in accordance with the purpose without any limitation and is preferably in the range of 1 nm to 500 nm, and more preferably in the range of 10 nm to 100 nm.

The average minor axis diameter of the metal nanowire body of less than 1 nm degrades the conductivity of the metal nanowire body, possibly hindering the transparent conductive film including the metal nanowire body having been processed by adsorption from serving as a conductive film. The average minor axis diameter of the metal nanowire body of greater than 500 nm might deteriorate the total light transmittance and haze of the transparent conductive film including the metal nanowire including the metal nanowire body having been processed by adsorption. On the other hand, the average minor axis diameter of the metal nanowire body within the aforementioned more preferable range is advantageous because such an average minor axis diameter imparts high conductivity and high transparency to the transparent conductive film including the metal nanowire including the metal nanowire body having been processed by adsorption.

The average major axis length of the metal nanowire body may be selected appropriately in accordance with the purpose without any limitation and is preferably in the range of 1 μm to 100 μm, more preferably in the range of 5 μm to 50 μm, and most preferably in the range of 20 μm to 50 μm.

The average major axis length of the metal nanowire body of 1 μm or less leads to difficulty in connecting one metal nanowire body with another, possibly hindering the transparent conductive film including the metal nanowire body from serving as a conductive film. The average major axis length of the metal nanowire body of greater than 100 μm might deteriorate the total light transmittance and haze of the transparent conductive film including the metal nanowire including the metal nanowire body having been processed by adsorption, or might deteriorate the dispersibility of the metal nanowire body having been processed by adsorption in the dispersion liquid used in the formation of the transparent conductive film. On the other hand, the average major axis length of the metal nanowire body within the aforementioned more preferable range or most preferable range is advantageous because such an average major axis length imparts high conductivity and high transparency to the transparent conductive film including the metal nanowire including the metal nanowire body having been processed by adsorption.

Meanwhile, the average minor axis diameter and the average major axis length of the metal nanowire body refer to the number average minor axis diameter and the number average major axis length that may be measured by a scanning electron microscope. More specifically, more than 100 metal nanowire bodies are subjected to the measurement, and from an image of each metal nanowire body taken by the scanning electron microscope, the projected diameter and the projected area of the corresponding nanowire are calculated with use of an image analysis device. The projected diameter is defined as the minor axis diameter. The major axis length is also calculated by the following formula.

Major axis length=Projected area/Projected diameter

The average minor axis diameter is defined by an arithmetic mean value of the minor axis diameters. The average major axis length is defined by an arithmetic mean value of the major axis lengths.

Additionally, the metal nanowire body may be in the form of a wire including beaded metal nanoparticles. In this case, the length is not subject to any limitation.

The coating amount of the metal nanowire body may be selected appropriately in accordance with the purpose without any limitation and is preferably in the range of 0.001 g/m² to 1.000 g/m², and more preferably in the range of 0.003 g/m² to 0.03 g/m².

The coating amount of the metal nanowire body of less than 0.001 g/m² might degrade the conductivity of the transparent conductive film due to insufficient presence of the metal nanowire body in the metal nanowire layer. The coating amount of the metal nanowire body of greater than 1.000 g/m² might deteriorate the total light transmittance and haze of the transparent conductive film. On the other hand, the coating amount of the metal nanowire body within the aforementioned more preferable range is advantageous because such a coating amount imparts high conductivity and high transparency to the transparent conductive film.

### —Method of Manufacturing Metal Nanowire—

The metal nanowire may be obtained by mixing the metal nanowire body, the colored compound, the solvent, and if necessary, the binder and a dispersant. The metal nanowire may be obtained, for example, by mixing the metal nanowire body and the solid-liquid mixture, which contains the atomized colored compound as a result of the processing according to the water flow dispersion method, the solvent, the binder, and the dispersant, followed by the processing of making the colored compound adsorb to the metal nanowire body (the surface processing) while the stirring at 20° C. for 5 minutes to 1 hour. The surface processing may also be followed by the process of removing a non-adsorbed colored compound by using centrifugation, filtering, or the like.

### <Binder>

The binder serves to disperse the metal nanowire and/or the metal nanowire body and is appropriately used in the dispersion liquid which is later described.

The binder may be selected appropriately in accordance with the purpose without any limitation. Examples of the binder include a known transparent natural polymeric resin and synthetic polymeric resin. The binder may also be a thermoplastic resin or a thermosetting (or a photo curable) resin which may be cured by heat, light, electron beams, and radiation. These examples may be used alone or in a combination of two or more.

The thermoplastic resin may be selected appropriately in accordance with the purpose without any limitation. Examples of the thermoplastic resin include polyvinyl chloride, a vinyl chloride-vinyl acetate copolymer, polymethyl methacrylate, cellulose nitrate, chlorinated polyethylene, chlorinated polypropylene, vinylidene fluoride, ethyl cellulose, hydroxypropylmethyl cellulose, polyvinyl alcohol, and polyvinyl pyrrolidone.

The thermosetting (or the photo curable) resin may be selected appropriately in accordance with the purpose without any limitation. Examples of the thermosetting (or the photo curable) resin include melamine acrylate, urethane acrylate, isocyanate, an epoxy resin, a polyimide resin, and a silicon resin such as acrylic-modified silicate. Examples of the thermosetting (or the photo curable) resin also include a polymer containing a photosensitive group, such as an azido group and a diazirine group, in at least one of its main chain and side chain.

### <Transparent Electrode Including Transparent Conductive Film>

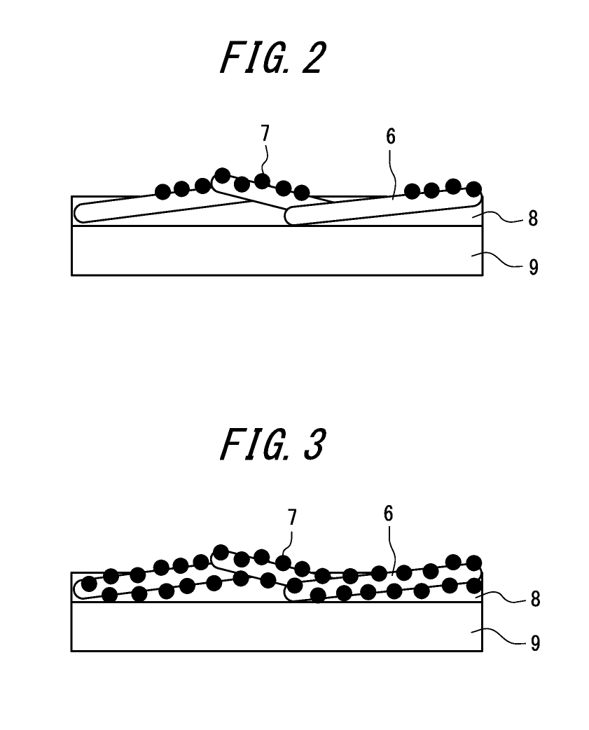

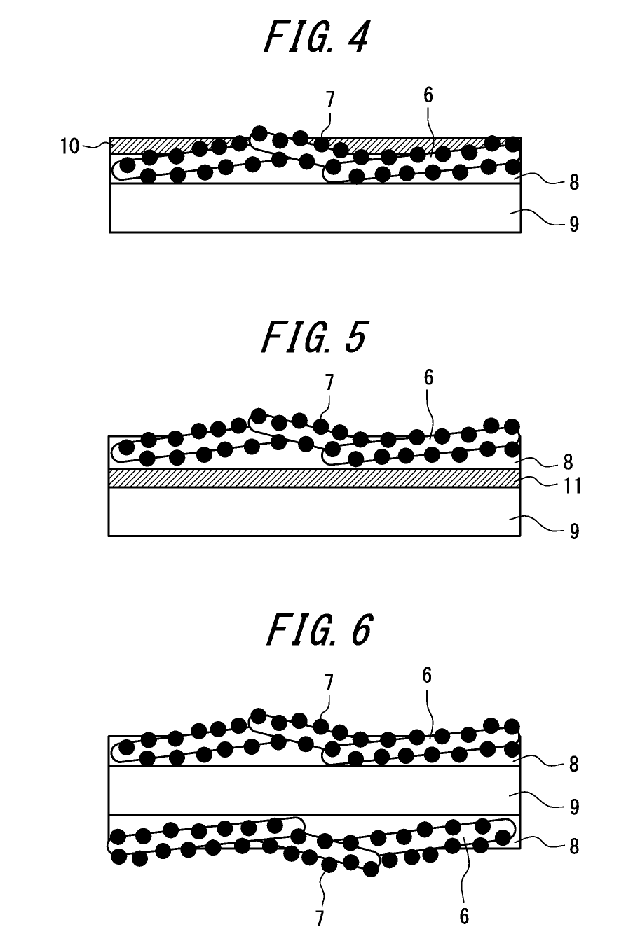

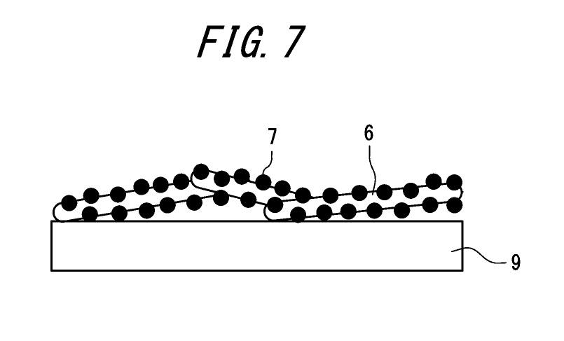

A transparent conductive film including the transparent conductive film may be selected appropriately in accordance with the purpose without any limitation. Examples of such a transparent electrode include (i) the one as illustrated in FIG. 2, where a colored compound (a dye) 7 is adsorbed to a portion of a metal nanowire body 6 that is exposed from a binder layer 8 (in this case, the colored compound (the dye) 7 may be adsorbed to the metal nanowire body 6, or may be present in a part of a surface of the binder layer 8 or in the binder layer 8), (ii) the one as illustrated in FIG. 3, where the metal nanowire body 6 and the colored compound 7 adsorbed to the metal nanowire body 6 are dispersed in the binder layer 8 formed on a substrate 9, and, (iii) the one as illustrated in FIG. 4, where an overcoat layer 10 is formed on the binder layer 8, (iv) the one as illustrated in FIG. 5, where an anchor layer 11 is formed between the binder layer 8 and the substrate 9, (v) the one as illustrated in FIG. 6, where the binder layers 8 are formed on both sides of the substrate 9, each binder layer 8 including the metal nanowire body 6 and the colored compound 7 adsorbed to the metal nanowire body 6, (vi) the one as illustrated in FIG. 7, where the metal nanowire body 6 and the colored compound 7 adsorbed to the metal nanowire body 6 (which collectively form the metal nanowire) are cumulated on top of the substrate 9 without the colored compound 7 being dispersed in the binder, and (vii) any appropriate combination of the examples (i) to (vi).

### <<Substrate>>

The substrate may be selected appropriately in accordance with the purpose without any limitation and is preferably a transparent substrate constituted by a material, such as an inorganic material or a plastic material, that has transmittance to visible light. The transparent substrate has a thickness required for the transparent electrode including the transparent conductive film. For example, the transparent substrate may be in the form of a film (a sheet) which is thin enough to remain flexible for bending or may be in the form of a basal plate which has a thickness by which moderate flexibility and rigidity are provided.

The inorganic material may be selected appropriately in accordance with the purpose without any limitation. Examples of the inorganic material include quartz, sapphire, and glass.

The plastic material may also be selected appropriately in accordance with the purpose without any limitation. Examples of the plastic material include a known polymeric material, such as triacetyl cellulose (TAC), polyester (TPEE), polyethylene terephthalate (PET), polyethylene naphthalate (PEN), polyimide (PI), polyamide (PA), aramid, polyethylene (PE), polyacrylate, polyethersulfone, polysulfone, polypropylene (PP), diacetyl cellulose, polyvinyl chloride, acrylic resins (PMMA), polycarbonate (PC), epoxy resins, urea resins, urethane resins, melamine resins, and cycloolefin polymers (COP). When such a plastic material is used to constitute the transparent substrate, the thickness of the transparent substrate is preferably, but not particularly limited to, in the range of 5 μm to 500 μm from the viewpoint of productivity.

### <<Overcoat Layer>>

Importantly, the overcoat layer has a light transmittance to visible light and may be constituted by a polyacryl-based resin, a polyamide-based resin, a polyester-based resin, or a cellulose-based resin. Alternatively, the overcoat layer may be constituted by a hydrolysis product or a dehydration condensation product of a metal alkoxide.

Furthermore, the overcoat layer has a thickness which does not adversely affect the light transmittance to visible light. The overcoat layer may also have at least one function selected from the function group consisting of a hard coat function, an anti-glare function, an anti-reflection function, an anti-Newton ring function, an anti-blocking function, and the like.

### <<Anchor Layer>>

The anchor layer, which ensures adhesion between the substrate and the binder layer, may be selected appropriately in accordance with the purpose without any limitation.

### <Method of Manufacturing Transparent Conductive Film>

In the following, a description is given of an embodiment of a method of manufacturing the transparent conductive film according to the present invention.

The method of manufacturing the transparent conductive film according to the present invention includes at least the dispersion film forming step and the curing step, and also includes, if necessary, the calendering step, the overcoat layer forming step, the pattern electrode forming step, and other steps.

The present embodiment of the method of manufacturing the transparent conductive film according to the present invention includes, for example, the dispersion film forming step, the curing step, and the calendering step, in this order.

### <<Dispersion Film Forming Step>>

The dispersion film forming step is forming a dispersion film on the substrate by using (i) the dispersion liquid according to the present invention that is later described or (ii) the dispersion liquid containing the colored compound, the metal nanowire body, the binder, and the solvent (i.e., the dispersion liquid in which the colored compound is not yet adsorbed to the metal nanowire body).

The metal nanowire and the method of manufacturing thereof, the colored compound and the method of manufacturing thereof, the metal nanowire body, and the binder are previously described. The solvent is described later.

The method of forming the dispersion film may be selected appropriately in accordance with the purpose without any limitation and is preferably a wet film forming method from the viewpoints of physical properties, convenience, and manufacturing cost.

The wet film forming method may also be selected appropriately in accordance with the purpose without any limitation. Examples of the wet film forming method include a known method such as a coating method, a spraying method, and a printing method.

The coating method may also be selected appropriately in accordance with the purpose without any limitation. Examples of the coating method include a micro-gravure coating method, a wire bar coating method, a direct gravure coating method, a die coating method, a dipping method, a spray coating method, a reverse roll coating method, a curtain coating method, a comma coating method, a knife coating method, and a spin coating method.

The spray method may also be selected appropriately in accordance with the purpose without any limitation.

The printing method may be selected appropriately in accordance with the purpose without any limitation. Examples of the printing method include anastatic, offset, gravure, intaglio, rubber plate, screen, and ink-jet printings.

### <<Curing Step>>

The curing step is curing the dispersion film formed on the substrate to obtain the cured product (e.g., the binder layer 8 including the metal nanowire body 6 and the colored compound 7 adsorbed to the surface of the metal nanowire body 6 as illustrated in FIGS. 2 to 6).

The curing step starts with removal of the solvent in the dispersion film formed on the substrate by drying. The removal of the solvent by drying may involve natural drying or heat drying. The drying is followed by a curing treatment of the uncured binder, and thus, the metal nanowire is dispersed in the cured binder. The curing treatment may be performed by heating and/or active energy ray radiation.

### <<Calendering Step>>

The calendering step is increasing smoothness of a surface and giving a glossy appearance to the surface.

The calendering processing reduces a value of resistance of the resulting transparent conductive film.

### <<Overcoat Layer Forming Step>>

The overcoat layer forming step, performed after the formation of the cured product from the dispersion film, is forming the overcoat layer on the cured product.

The overcoat layer may be formed, for example, by applying, over the cured product, a coating liquid containing a predetermined material for forming the overcoat layer and by curing the applied coating liquid.

### <<Pattern Electrode Forming Step>>

The pattern electrode forming step, performed after the formation of the transparent conductive film on the substrate, is forming a pattern electrode by applying a known photolithography process. This makes the transparent conductive film according to the present invention applicable to a sensor electrode for a capacitive touch panel. Additionally, when the curing treatment performed in the curing step involves active energy ray radiation, the curing treatment may include mask exposure/development to form the pattern electrode.

### (Dispersion Liquid)

The dispersion liquid according to the present invention contains at least the metal nanowire and also contains, if necessary, the binder, the solvent, the dispersant, other additives, or the like. As described earlier, the metal nanowire includes the metal nanowire body and the colored compound adsorbed to the metal nanowire body, the colored compound having the number average particle diameter in the range of 0.03 μm to 0.5 μm.

The metal nanowire and the method of manufacturing thereof, the metal nanowire body, and the colored compound and the method of manufacturing thereof are previously described.

The way of dispersing the dispersion liquid may be selected appropriately in accordance with the purpose without any limitation. For example, agitation, ultrasonic dispersion, bead dispersion, kneading, a homogenizer process, and a pressurize dispersion process may be preferable.

The amount of the metal nanowire body included in the metal nanowire in the dispersion liquid may be selected appropriately in accordance with the purpose without any limitation and is preferably in the range of 0.01 part by mass to 10.00 parts by mass based on 100 parts by mass of the dispersion liquid.

The amount of the metal nanowire body included in the metal nanowire of less than 0.01 part by mass might result in failure to obtain satisfactory coating amount (0.001 g/m² to 1.000 g/m²) of the metal nanowire body in the final transparent conductive film. The amount of the metal nanowire body included in the metal nanowire of greater than 10.00 parts by mass might deteriorate the dispersibility of the metal nanowire.

### <Binder>

The binder is described previously.

### <Solvent>

The solvent, which is capable of maintaining the number average particle diameter of the colored compound to be in the range of 0.03 μm to 0.5 μm and also capable of dispersing the metal nanowire and/or the metal nanowire body, may be selected appropriately in accordance with the purpose without any limitation. Examples of the solvent include: water; alcohol, such as methanol, ethanol, n-propanol, i-propanol, n-butanol, i-butanol, sec-butanol, and tert-butanol; anone, such as cyclohexanone and cyclopentanone; amide, such as N,N-dimethylformamide (DMF); and sulfide, such as dimethyl sulfoxide (DMSO). These examples may be used alone or in a combination of two or more.

Among these examples, an aqueous solvent is preferable from the viewpoint of preventing the scattering of natural light. The aqueous solvent herein refers to a solvent containing at least water.

Additionally, it is preferable to select a solvent which does not swell the binder in the dispersion liquid. The reason is that the use of a solvent which swells the binder causes the binder to incorporate the colored compounds excessively, possibly deteriorating the transparency of the transparent conductive film.

### <Dispersant>

The dispersant may be selected appropriately in accordance with the purpose without any limitation. Examples of the dispersant include: polyvinylpyrrolidone (PVP); a compound containing an amino group, such as polyethyleneimine; and a compound which may be adsorbed to a metal and which contains a functional group, such as a sulfo group (including a sulfonate salt), a sulfonyl group, a sulfonamide group, a carboxylic acid group (including a carboxylate salt), an amide group, a phosphate group (including a phosphate and a phosphate ester), a phosphino group, a silanol group, an epoxy group, an isocyanate group, a cyano group, a vinyl group, a thiol group, and a carbinol group. These examples may be used alone or in a combination of two or more.

The dispersant may also be adsorbed to the surface of the metal nanowire or the metal nanowire body. This enhances the dispersibility of the metal nanowire or the metal nanowire body.

When the dispersant is added in the dispersion liquid, the amount of the dispersant is preferably determined not to deteriorate the conductivity of the final transparent conductive film. By doing so, the dispersant may adsorb to the metal nanowire or the metal nanowire body in the amount that does not deteriorate the conductivity of the transparent conductive film.

### <Other Additives>

The other additives may be selected appropriately in accordance with the purpose without any limitation. Examples of the other additives include a thickening agent and a surfactant.

### (Information Input Device)

An information input device according to the present invention includes at least a known transparent substrate and the transparent conductive film according to the present invention and also includes, if necessary, other known members (as described in Japanese Patent No. 4893867). With the transparent conductive film according to the present invention, the information input device is highly cap able of preventing black floating (i.e., improving bright-room contrast) and has excellent invisibility of the electrode pattern.

The information input device may be in any form selected appropriately in accordance with the purpose without any limitation and may be, for example, a touch panel as described in Japanese Patent No. 4893867.

### (Electronic Equipment)

An electronic equipment according to the present invention includes at least a known display panel and the transparent conductive film according to the present invention and also includes, if necessary, other known members (as described in U.S. Pat. No. 4,893,867). With the transparent conductive film according to the present invention, the electronic equipment is highly capable of preventing black floating (i.e., improving bright-room contrast) and has excellent invisibility of the electrode pattern.

The electronic equipment may be in any form selected appropriately in accordance with the purpose without any limitation and may be, for example, a television, a digital camera, a notebook personal computer, a video camera, or a mobile terminal device as described in Japanese Patent No. 4893867.

### EXAMPLES

The present invention will be explained below in greater detail through Examples and Comparative Examples. However, these Examples are not to be construed as in any way limitative on the invention.

### Example 1

### Preparation of Colored Compounds

Colored compounds were prepared by the following procedure.

Lanyl Black BG E/C (manufactured by Okamoto Dyestuff Co., Ltd.), which is a dye containing Cr complex, was mixed with 2-aminoethanethiol hydrochloride (manufactured by Wako Pure Chemical Industries, Ltd.), which is a molecule containing the basic groups, in an aqueous solvent at a mass ratio of 4:1. Subsequently, the mixture was reacted for 100 minutes by using an ultrasonic cleaner and then, left for 15 hours. After that, the obtained reaction liquid was filtrated through a mixed cellulose ester membrane filter having a pore size of 3 μm, and thus, a solid matter was obtained. The obtained solid matter was rinsed with water 3 times, dried in a vacuum oven at 100° C., and then, added with ethanol to prepare a 0.2% by mass ethanol solution. Subsequently, “BERYU MINI” (which is provided with a diamond nozzle having a diameter of 0.29 mm, i.e., 290 μm, and a length of 10 mm) manufactured by Beryu Co., Ltd. was used, and the plunger pump was regulated to obtain a pressure of 100 MPa in the inlet of the nozzle to subject the prepared ethanol solution to the processing according to the water flow dispersion method. This processing was repeated 3 times, and thus, the colored compounds were obtained.

Furthermore, the number average particle diameter of the obtained colored compounds was measured by Laser Zeta Potential Meter “ELS-8000” manufactured by Otsuka Electronics Co., Ltd.

### <Preparation of Silver Nanowire Ink (Dispersion Liquid)>

Silver nanowire ink with the following composition was prepared.

(1) Metal nanowire bodies: silver nanowires (manufactured by Seashell Technology, LLC. with the product name AgNW-25, having an average diameter of 25 nm and an average length of 23 μm): an amount of 0.05 part by mass in the composition.
(2) The colored compounds prepared as described above (the 0.2% by mass ethanol solution): 0.01 part by mass as the ethanol solution.
(3) Binder: hydroxypropyl methylcellulose (manufactured by Aldrich Corporation, a 2% by mass hydroxypropyl methylcellulose solution having a viscosity in the range of 80 cP to 120 cP at 20° C.): 0.15 part by mass.
(4) Solvent: (i) water: an amount of 89.79 parts by mass in the composition and (ii) ethanol: an amount of 10.00 parts by mass in the composition.

### <Formation of Silver Nanowire Transparent Electrode (Silver Nanowire Transparent Conductive Film)>

The prepared silver nanowire ink (the dispersion liquid) was coated onto a transparent substrate (PET: manufactured by Toray Industries, Inc., with the product name U34 and a thickness of 125 μm) by using a (#10) wire bar, and thus, a silver nanowire dispersion film was formed. At this time, the coating amount of the silver nanowires was approximately 0.01 g/m².

Subsequently, by blowing hot air from a dryer to the coated surface in the atmosphere, the solvent contained in the silver nanowire dispersion film was dried and removed.

After that, the product was left in an oven at 120° C. for 5 minutes to heat and cure the binder.

Then, by using a calendering processor including a cylindrical press roll and a back roll (which are both made of steel), the calendering processing (at a load of 4 kN and a speed of 1 m/min) was performed. Thus, the silver nanowire transparent conductive film was obtained. The obtained silver nanowire transparent conductive film was evaluated as follows.

### <<Sheet Resistance>>

A manual type non-damage resistance measurement instrument (manufactured by Napson Corporation, with the product name EC-80P) was placed into contact with the surface of the silver nanowire transparent conductive film, and the value of resistance was measured. The measurement was conducted at 12 randomly chosen positions on the surface of the silver nanowire transparent conductive film, and an average value of the measurement values was defined as the sheet resistance. Furthermore, for reference, the same measurement was conducted for a PET transparent substrate not including a conductive film.

### <<Reflection L* Value and Δ Reflection L* Value>>

A black vinyl tape (manufactured by NICHIBAN Co., Ltd., with the product name VT-50) was adhered to the opposite surface of the surface on which the silver nanowire transparent conductive film was formed, and the value of reflection was measured from the side of the surface on which the silver nanowire transparent conductive film was formed by using Color i5 manufactured by X-Rite, Inc. in accordance with JIS Z8722. The measurement was conducted at 3 randomly chosen positions on the substrate surface, and an average value of the measurement values was defined as the reflection L* value. Furthermore, the same measurement was conducted for a PET transparent substrate not including a conductive film, and a difference between the reflection L* value of this PET transparent substrate and the above reflection L* value was calculated as a Δ reflection L* value.

### <<Evaluation of Visibility Improvement>>

In adjacent to the region where the silver nanowire transparent conductive film including the colored compounds were formed, metal nanowire ink not including colored compounds was coated to the substrate, and thus, a film not including colored compounds was formed on the substrate. Subsequently, the black vinyl tape (manufactured by NICHIBAN Co., Ltd., with the product name VT-50) was adhered to the opposite surface of the surface of the substrate on which these films were formed. Then, these films were visually observed from the side of the surface on which these films were formed, and occurrence of the black floating was evaluated based on the following evaluation criteria.

### —Evaluation Criteria—

Good: The border region between the two films was observed visually, and improvement was found in the visibility of the silver nanowire transparent conductive film including the colored compounds.

Poor: The border region between the two films was difficult to observe visually, and improvement was not found in the visibility of the silver nanowire transparent conductive film including the colored compounds.

### Example 2

A silver nanowire transparent conductive film was formed in the same manner as Example 1, except that the pressure in the inlet of the nozzle was changed from 100 MPa, as in Example 1, to 150 MPa in the water flow dispersion method, and the number average particle diameter of the colored compounds, and the sheet resistance, the reflection L* value, and improvement in the visibility were evaluated.

### Example 3

A silver nanowire transparent conductive film was formed in the same manner as Example 1, except that the number of repetitions of the processing according to the water flow dispersion method was changed from 3 times, as in Example 1, to 10 times, and the number average particle diameter of the colored compounds, and the sheet resistance, the reflection L* value, and improvement in the visibility were evaluated.

### Example 4

A silver nanowire transparent conductive film was formed in the same manner as Example 1, except that the pressure in the inlet of the nozzle was changed from 100 MPa, as in Example 1, to 150 MPa in the water flow dispersion method and that the number of times of the processing according to the water flow dispersion method was changed from 3 times, as in Example 1, to 10 times, and the number average particle diameter of the colored compounds, and the sheet resistance, the reflection L* value, and improvement in the visibility were evaluated.

### Comparative Example 1

A silver nanowire transparent conductive film was formed in the same manner as Example 1, except that the colored compounds used in Example 1 were not added, and the sheet resistance, the reflection L* value, and improvement in the visibility were evaluated.

### Comparative Example 2

A silver nanowire transparent conductive film was formed in the same manner as Example 1, except that the processing according to the water flow dispersion method implemented in Example 1 was omitted, and the number average particle diameter of the colored compounds, and the sheet resistance, the reflection L* value, and improvement in the visibility were evaluated.

### Example 5

### Preparation of Colored Compound

A colored compounds were prepared in the same manner as Example 1, except that the pressure in the inlet of the nozzle was changed from 100 MPa, as in Example 1, to 150 MPa in the water flow dispersion method and that the number of times of the processing according to the water flow dispersion method was changed from 3 times, as in Example 1, to 10 times.

Furthermore, the number average particle diameter of the prepared colored compounds was measured by using Laser Zeta Potential Meter “ELS-8000” manufactured by Otsuka Electronics Co., Ltd.

### <Preparation of Silver Nanowire Ink (Dispersion Liquid)>

Silver nanowire ink with the following composition was prepared.

(1) Metal nanowire bodies: silver nanowires (manufactured by Seashell Technology, LLC. with the product name AgNW-25, having an average diameter of 25 nm and an average length of 23 μm): an amount of 0.06 part by mass in the composition.
(2) The colored compounds prepared as described above (the 0.2% by mass ethanol solution): 0.01 part by mass as the ethanol solution.
(3) Binder: a water soluble photosensitive resin (manufactured by Toyo Gosei Co., Ltd., with the product name BIOSURFINE AWP: 0.15 part by mass.
(4) Dispersant: polyvinyl pyrrolidone K30 (polyvinyl pyrrolidone manufactured by Wako Pure Chemical Industries, Ltd.): 0.02 part by mass.
(5) Solvent: (i) water: an amount of 89.76 parts by mass in the composition and (ii) ethanol: an amount of 10.00 parts by mass in the composition.

### <Formation of Silver Nanowire Transparent Electrode (Silver Nanowire Transparent Conductive Film)>

The prepared silver nanowire ink (the dispersion liquid) was coated onto the transparent substrate (PET: manufactured by Toray Industries, Inc., with the product name U34 and a thickness of 125 μm) by using the (#10) wire bar, and thus, a silver nanowire dispersion film was formed. At this time, the coating amount of the silver nanowires was approximately 0.01 g/m².

Subsequently, by blowing hot air from the dryer to the coated surface in the atmosphere, the solvent included in the silver nanowire dispersion film was dried and removed.

After that, the product was left in the oven at 120° C. for 5 minutes to dry and remove the solvent further. Then, by irradiating the transparent conductive film with an ultraviolet ray emitted from a metal halide lamp at a cumulative amount of light of 400 mJ/cm² under a nitrogen atmosphere, the binder was cured.

Then, by using the calendering processor including the cylindrical press roll and the back roll (which are both made of steel), the calendering processing (at a load of 4 kN and a speed of 1 m/min) was performed. Thus, the silver nanowire transparent conductive film was obtained. As in Example 1, the sheet resistance, the reflection L* value, and improvement in the visibility of the obtained silver nanowire transparent conductive film were evaluated.

### Comparative Example 3

A silver nanowire transparent conductive film was formed in the same manner as Example 5, except that the colored compounds used in Example 5 were not added, and the sheet resistance, the reflection L* value, and improvement in the visibility were evaluated.

### Comparative Example 4

A silver nanowire transparent conductive film was formed in the same manner as Example 5, except that the processing according to the water flow dispersion method implemented in Example 5 was omitted, and the number average particle diameter of the colored compounds, and the sheet resistance, the reflection L* value, and improvement in the visibility were evaluated.

### Example 6

A silver nanowire transparent conductive film was formed in the same manner as Example 3, except that the pressure in the inlet of the nozzle was changed from 100 MPa, as in Example 3, to 200 MPa in the water flow dispersion method, and the number average particle diameter of the colored compounds, and the sheet resistance, the reflection L* value, and improvement in the visibility were evaluated.

### Example 7

A silver nanowire transparent conductive film was formed in the same manner as Example 3, except that the pressure in the inlet of the nozzle was changed from 100 MPa, as in Example 3, to 50 MPa in the water flow dispersion method, and the number average particle diameter of the colored compounds, and the sheet resistance, the reflection L* value, and improvement in the visibility were evaluated.

### Comparative Example 5

A silver nanowire transparent conductive film was formed in the same manner as Example 1, except that the pressure in the inlet of the nozzle was changed from 100 MPa, as in Example 1, to 50 MPa in the water flow dispersion method, and the number average particle diameter of the colored compounds, and the sheet resistance, the reflection L* value, and improvement in the visibility were evaluated.

### Comparative Example 6

A silver nanowire transparent conductive film was formed in the same manner as Example 1, except that the pressure in the inlet of the nozzle was changed from 100 MPa, as in Example 1, to 20 MPa in the water flow dispersion method, and the number average particle diameter of the colored compounds, and the sheet resistance, the reflection L* value, and improvement in the visibility were evaluated.

### Example 8

A silver nanowire transparent conductive film was formed in the same manner as Example 1, except that “water and ethanol” contained in the solvent used in the preparation of the silver nanowire ink in Example 1 was substituted by “water only” and that the pressure in the inlet of the nozzle was changed from 100 MPa, as in Example 1, to 150 MPa in the water flow dispersion method, and the number average particle diameter of the colored compounds, and the sheet resistance, the reflection L* value, and improvement in the visibility were evaluated.

### Example 9

A silver nanowire transparent conductive film was formed in the same manner as Example 1, except that 10.00 parts by mass of ethanol contained in the solvent used in the preparation of the silver nanowire ink was substituted by 10.00 parts by mass of n-propanol, and the number average particle diameter of the colored compounds, and the sheet resistance, the reflection L* value, and improvement in the visibility were evaluated.

### Example 10

A silver nanowire transparent conductive film was formed in the same manner as Example 1, except that the number of times of the processing according to the water flow dispersion method was changed from 3 times, as in Example 1, to 1 time, and the number average particle diameter of the colored compounds, and the sheet resistance, the reflection L* value, and improvement in the visibility were evaluated.

Table 1 shows results of the evaluation.

TABLE 1

| | Reference | | | | | Comparative | Comparative | | Comparative |
|---|---|---|---|---|---|---|---|---|---|
| | Example | Example 1 | Example 2 | Example 3 | Example 4 | Example 1 | Example 2 | Example 5 | Example 3 |
| Implementation of water | No | Yes | Yes | Yes | Yes | No | No | Yes | No |
| flow dispersion method | | | | | | | | | |
| Nozzle diameter [μm] | — | 290 | 290 | 290 | 290 | — | — | 290 | — |
| Nozzle length [mm] | — | 10 | 10 | 10 | 10 | — | — | 10 | — |
| Pressure in inlet [Mpa] | — | 100 | 150 | 100 | 150 | — | — | 150 | — |
| Processing times | — | 3 | 3 | 10 | 10 | — | — | 10 | — |
| [number of times] | | | | | | | | | |
| Number average particle | — | 0.30 | 0.25 | 0.10 | 0.05 | — | 0.60 | 0.10 | — |
| diameter of colored | | | | | | | | | |
| compounds [μm] | | | | | | | | | |
| Presence of dispersant | — | No | No | No | No | No | No | Yes | Yes |
| Solvent | — | Water, | Water, | Water, | Water, | Water, | Water, | Water, | Water, |
| | | ethanol | ethanol | ethanol | ethanol | ethanol | ethanol | ethanol | ethanol |
| Sheet resistance [Ω/sq] | — | 96 | 98 | 100 | 109 | 98 | 102 | 138 | 88 |
| Reflection L* value | 6.8 | 9.4 | 9.3 | 9.0 | 8.9 | 9.6 | 9.9 | 9.4 | 10.0 |
| Δ Reflection L* value | 0 | 2.6 | 2.5 | 2.2 | 2.1 | 2.8 | 3.1 | 2.6 | 3.2 |
| Improvement in | — | Good | Good | Good | Good | Poor | Poor | Good | Poor |

| | Comparative | | | Comparative | Comparative | | | |
|---|---|---|---|---|---|---|---|---|
| | Example 4 | Example 6 | Example 7 | Example 5 | Example 6 | Example 8 | Example 9 | Example 10 |
| Implementation of water | No | Yes | Yes | Yes | Yes | Yes | Yes | Yes |
| flow dispersion method | | | | | | | | |
| Nozzle diameter [μm] | — | 290 | 290 | 290 | 290 | 290 | 290 | 290 |
| Nozzle length [mm] | — | 10 | 10 | 10 | 10 | 10 | 10 | 10 |
| Pressure in inlet [Mpa] | — | 200 | 50 | 50 | 20 | 150 | 100 | 100 |
| Processing times | — | 10 | 10 | 3 | 3 | 3 | 3 | 1 |
| [number of times] | | | | | | | | |
| Number average particle | 0.60 | 0.03 | 0.52 | 0.58 | 0.59 | 0.30 | 0.30 | 0.45 |
| diameter of colored | | | | | | | | |
| compounds [μm] | | | | | | | | |
| Presence of dispersant | Yes | No | No | No | No | No | No | No |
| Solvent | Water, | Water, | Water, | Water, | Water, | Water | Water, | Water, |
| | ethanol | ethanol | ethanol | ethanol | ethanol | | n-propanol | ethanol |
| Sheet resistance [Ω/sq] | >1,000 | 105 | 93 | 95 | 104 | 102 | 97 | 97 |
| Reflection L* value | 10.2 | 8.8 | 9.5 | 9.7 | 9.8 | 9.3 | 9.4 | 9.7 |
| Δ Reflection L* value | 3.4 | 2.0 | 2.7 | 2.9 | 3.0 | 2.5 | 2.6 | 2.9 |
| Improvement in | Poor | Good | Good | Poor | Poor | Good | Good | Good |

The results of Examples and Comparative Examples shown in Table 1 indicate that the transparent conductive film according to the present invention, which includes the metal nanowires including the metal nanowire bodies and the colored compounds adsorbed to the metal nanowire bodies, the colored compounds having a number average particle diameter in the range of 0.03 μm to 0.5 μm, has a low sheet resistance and a low reflection L* value and therefore is capable of preventing the scattering of natural light. The results also indicate that the processing of the colored compound according to the water flow dispersion method is preferably to be implemented in order to achieve the number average particle diameter within the above range.

### INDUSTRIAL APPLICABILITY

The transparent conductive film and the dispersion liquid according to the present invention are particularly suitable for use in a touch panel, and they may also be used in applications other than a touch panel (e.g., an organic EL electrode, a surface electrode of a solar panel, a transparent antenna such as a wireless charger antenna for a mobile or a smart phone, and a transparent heater which may be used to prevent dew condensation).

### REFERENCE SIGNS LIST

1 feed container
2 pump
3 nozzle
4 heat exchanger
5 receiving container
6 metal nanowire body
7 colored compound
8 binder layer
9 substrate
10 overcoat layer
11 anchor layer

1. A transparent conductive film comprising at least one metal nanowire, wherein:
the at least one metal nanowire includes a metal nanowire body and a colored compound adsorbed to the metal nanowire body, and
the colored compound has a number average particle diameter in the range of 0.03 μm to 0.5 μm.

2. The transparent conductive film of claim 1, wherein
the colored compound includes a chromophoric group having absorption in a visible light region and a group bonded to a metal constituting the metal nanowire body.

3. The transparent conductive film of claim 1, wherein
the colored compound absorbs light in the visible light region.

4. The transparent conductive film of claim 1, wherein
the metal nanowire body has an average minor axis diameter in the range of 1 nm to 500 nm and an average major axis length in the range of 5 μm to 50 μm.

5. The transparent conductive film of claim 1, further comprising a binder, wherein
the at least one metal nanowire is dispersed in the binder.

6. The transparent conductive film of claim 2, wherein
the colored compound is represented by the formula R-X, where R is the chromophoric group having absorption in the visible light region, and X is the group bonded to the metal constituting the metal nanowire body.

7. The transparent conductive film of claim 2, wherein
the chromophoric group includes at least one selected from the group consisting of an unsaturated alkyl group, an aromatic group, a heterocyclic ring, and a metal ion.

8. The transparent conductive film of claim 2, wherein
the chromophoric group includes at least one selected from the group consisting of a nitroso group, a nitro group, an azo group, a methine group, an amino group, a ketone group, a thiazolyl group, a naphthoquinone group, an indoline group, a stilbene derivative, an indophenol derivative, a diphenylmethane derivative, an anthraquinone derivative, a triarylmethane derivative, a diazine derivative, an indigoid derivative, a xanthene derivative, an oxazine derivative, a phthalocyanine derivative, an acridine derivative, a thiazine derivate, a sulfur atom-containing compound, and a metal ion-containing compound.

9. The transparent conductive film of claim 8, wherein
the chromophoric group includes at least one selected from the group consisting of a Cr complex, a Cu complex, a Co complex, a Ni complex, a Fe complex, an azo group, and an indoline group.

10. The transparent conductive film of claim 2, wherein
the group bonded to the metal comprises any one of a thiol group, a carboxylic acid group, and a phosphate group.

11. The transparent conductive film of claim 1, wherein
the metal nanowire body comprises at least one element selected from the group consisting of Ag, Au, Ni, Cu, Pd, Pt, Rh, Ir, Ru, Os, Fe, Co, Sn, Al, Tl, Zn, Nb, Ti, In, W, Mo, Cr, V, and Ta.

12. The transparent conductive film of claim 1, wherein
a reflection L* value of the transparent conductive film is 9.5 or less.

13. The transparent conductive film of claim 1, wherein
the at least one metal nanowire is accumulated on a top of a substrate.

14. The transparent conductive film of claim 1, wherein
the colored compound has been processed according to a water flow dispersion method.

15. The transparent conductive film of claim 14, wherein
the water flow dispersion method comprises the step of flowing a solid-liquid mixture including the colored compound through a nozzle having a diameter of 1 mm or less and a length of 0.1 mm or more under a pressure of 50 MPa or more in an inlet of the nozzle.

16. The transparent conductive film of claim 15, wherein
the step of flowing the solid-liquid mixture is repeated at least 3 times.

17. The transparent conductive film of claim 15, wherein
the pressure is 100 MPa or more.

18. A dispersion liquid comprising at least one metal nanowire, wherein:
the at least one metal nanowire includes a metal nanowire body and a colored compound adsorbed to the metal nanowire body, and
the colored compound has a number average particle diameter in the range of 0.03 μm to 0.5 μm.

19. The dispersion liquid of claim 18, wherein
the colored compound includes a chromophoric group having absorption in a visible light region and a group bonded to a metal constituting the metal nanowire body.

20. The dispersion liquid of claim 18, wherein
the metal nanowire body has an average minor axis diameter in the range of 1 nm to 500 nm and an average major axis length in the range of 5 μm to 50 μm.

21. The dispersion liquid of claim 18, further comprising an aqueous solvent.

22. An information input device, comprising:
a transparent substrate; and
the transparent conductive film of claim 1 that is disposed on the transparent substrate.

23. An electronic equipment, comprising:
a display panel; and
the transparent conductive film of claim 1 that is disposed on the display panel.
